(19) United States
(12) Patent Application Publication
(10) Pub. No.: US 2026/0134729 A1
(43) Pub. Date: May 14, 2026

(54) IN-VEHICLE EDGE PROCESSING OF TIME-SERIES DATA

(71) Applicant: Rivian IP Holdings, LLC, Irvine, CA (US)

(72) Inventors: Aditya PUROHIT, Irvine, CA (US); Sunil BHAGWATH, Dublin, CA (US)

(21) Appl. No.: 19/383,370

(22) Filed: Nov. 7, 2025

Related U.S. Application Data
(60) Provisional application No. 63/718,443, filed on Nov. 8, 2024.

(51) Int. Cl. G07C 5/10; G07C 5/08

(52) U.S. Cl. CPC G07C 5/10; G07C 5/085

(57) ABSTRACT

In an embodiment, a method includes receiving, by a vehicle control system for a vehicle, one or more first time-series inputs associated with a first time window, where the one or more first time-series inputs relate to one or more signals generated within the vehicle. The method also includes applying, by the vehicle control system, a first function to the one or more first time-series inputs to generate a first value of a first metric for the first time window. The method also includes storing, by the vehicle control system, the first value of the first metric in the vehicle in a first bin in association with the first time window.

### CROSS-REFERENCE TO RELATED APPLICATIONS

This application claims the benefit of priority of U.S. Provisional Patent Application Serial No. 63/718,443, filed on November 8, 2024, which is hereby incorporated by reference in its entirety as though fully and completely set forth herein.

### INTRODUCTION

The present disclosure relates to edge processing. In particular, the present disclosure relates to techniques for processing time-series data on an edge device, such as a vehicle.

### SUMMARY

In an embodiment, one general aspect includes a method for in-vehicle edge processing of time-series data. The method includes receiving, by a vehicle control system for a vehicle, one or more first time-series inputs associated with a first time window, where the one or more first time-series inputs relate to one or more signals generated within the vehicle. The method also includes applying, by the vehicle control system, a first function to the one or more first time-series inputs to generate a first value of a first metric for the first time window. The method also includes storing, by the vehicle control system, the first value of the first metric in the vehicle in a first bin in association with the first time window.

In an embodiment, another general aspect includes a system for in-vehicle edge processing of time-series data. The system includes one or more memories having executable instructions. The system also includes one or more processors in data communication with the one or more memories and configured to execute the executable instructions to receive one or more first time-series inputs associated with a first time window, where the one or more first time-series inputs relate to one or more signals generated within a vehicle. The one or more processors are further configured to execute the executable instructions to apply a first function to the one or more first time-series inputs to generate a first value of a first metric for the first time window. The one or more processors are further configured to execute the executable instructions to store the first value of the first metric in the vehicle in a first bin in association with the first time window.

In an embodiment, another general aspect includes a computer-program product including a non-transitory computer-usable medium having computer-readable program code embodied therein. The computer-readable program code is adapted to be executed to implement a method. The method includes receiving one or more first time-series inputs associated with a first time window, where the one or more first time-series inputs relate to one or more signals generated within a vehicle. The method also includes applying a first function to the one or more first time-series inputs to generate a first value of a first metric for the first time window. The method also includes storing the first value of the first metric in the vehicle in a first bin in association with the first time window

### BRIEF DESCRIPTION OF THE DRAWINGS

FIG. 1A illustrates an example vehicle in accordance with certain embodiments.

FIG. 1B illustrates a chassis of a vehicle in accordance with certain embodiments.

FIG. 2A is a schematic block diagram of components of a vehicle in accordance with certain embodiments.

FIG. 2B is a schematic block diagram of alternative components of a vehicle in accordance with certain embodiments.

FIG. 3 illustrates an example environment for a Telematics Control Module (TCM) in accordance with certain embodiments.

FIG. 4 illustrates example operation of the TCM of FIG. 3 in accordance with certain embodiments.

FIG. 5 illustrates an example environment for estimating vehicle battery charge time in accordance with certain embodiments.

FIG. 6 illustrates an example of a process for maintaining metric values based on time-series inputs within a vehicle in accordance with certain embodiments.

FIG. 7 illustrates an example of a process for responding to queries for metric values stored within a vehicle in accordance with certain embodiments

### DETAILED DESCRIPTION

Machine learning (ML) models are increasingly being implemented on edge devices to provide advanced functionality to such devices. For example, in the vehicle setting, an ML model is capable of providing more accurate vehicle battery charge time predictions relative to conventional physics models. However, because performing inference via a ML model generally requires significant compute and bandwidth resources, implementing a ML model on an edge device presents a number of challenges.

One such challenge is the compute constraints of edge devices. In order to avoid this limitation, conventional approaches commonly perform inference via a cloud-based service. Although such approaches significantly reduce the compute and power requirements of edge devices, these approaches are less effective when inference is performed with large input data sets of time-series data. For example, in the vehicle setting, vehicle electronic control units (ECUs) may generate large amounts of raw time-series data at high sampling rates (e.g., every 10ms or less). Consequently, transmitting such time-series data to the cloud consumes significant bandwidth and may be prohibitively expensive to perform over a wireless wide area network (WWAN). Additionally, due to the size of the input data set, the latency associated with transmitting data to the cloud and receiving an inference result from a ML model may lead to a poor user experience.

Other approaches have attempted to perform inference via an ML model being executed on the edge device itself. In use cases that involve large datasets, however, the edge device may not have sufficient compute and/or data bandwidth to effectively perform inference with reasonable latency. Additionally, such approaches may result in significant power consumption by the edge device. Accordingly, improved techniques for implementing ML models on edge devices are needed.

In various embodiments described here, a signal aggregator receives input data from one or more vehicle ECUs and/or other data producers (e.g., via a Controller Area Network (CAN) bus, via Ethernet, etc.) and pre-processes the input data to generate one or more metrics. The metric(s) may be generated on a per bin basis based on a selected time window (e.g., a 1 millisecond (ms) time window, 10ms time window, 100ms time window, 500ms time window, 1s time window, 5s time window, 10s time window, etc.), for example, by applying a function to the input data (e.g., min, max, sum, count, range, mean, median, mode, variance, standard deviation, etc.). The metric(s) for each bin may be output to one or more consumers (e.g., a ML model or other application executing on the edge device or in the cloud) automatically or in response to requests, significantly reducing the amount of data that is transmitted to and processed by these consumers.

For example, in a vehicle setting that implements a ML model for estimating a vehicle battery charge time, a particular type of input data received by the signal aggregator via the CAN bus or Ethernet may have a sampling rate of 100 Hz and may be processed by the signal aggregator to generate a metric for each 100ms time window. In such embodiments, the signal aggregator could generate a value for the metric for each time window (e.g., a mean of the input data for each 100ms time window). The metric for each bin could then be output to the vehicle battery charge time estimation ML model, reducing the amount of input data required to be processed by the ML model and thus decreasing compute and bandwidth requirements for performing inference via the ML model. Once a result is generated by the ML model, the result may be published to the cloud, to a mobile device, and/or to one or more other devices or applications executing within the vehicle. In various embodiments, the signal aggregator may additionally or alternatively output the pre-processed data to one or more other consumers, such as other applications executing in the vehicle or in the cloud. For example, pre-processed data may be outputted by the signal aggregator to the cloud to train a ML model.

In various embodiments, the ML model and/or other application executing on the edge device and/or in the cloud may query the signal aggregator (e.g., using a variable request format) for one or more types of input data. For example, in a vehicle setting, each of a plurality of different ECUs may implement a different signal aggregator, and each signal aggregator may implement a uniform application programming interface (API), enabling different applications to query data from different ECUs in substantially the same manner.

In various embodiments, the signal aggregator may store input data in volatile memory (e.g., RAM, HBM, etc.) prior to pre-processing the input data to avoid excessive write cycles to nonvolatile memory, such as a solid-state drive (SSD). Once input data is pre-processed, metric(s) associated with each bin may be stored in nonvolatile memory, such as a SSD, to enable the metrics to be queried by one or more applications. In some embodiments, the size of the time window associated with each bin of input data may be selected such that multiple consumers having different data requirements can effectively utilize the metrics. For example, if data consumer A requires a sampling rate of 10 Hz (e.g., corresponding to 100ms time windows) and data consumer B requires a sampling rate of 2 Hz (e.g., corresponding to 500ms time windows), then the signal aggregator may implement 100ms time windows in order to provide metrics at a granularity that is suitable for both data consumer A and data consumer B.

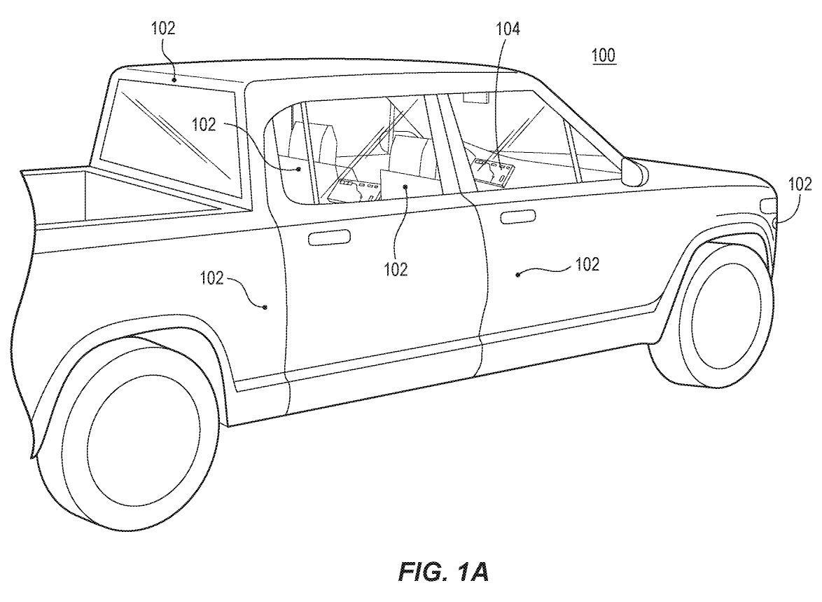

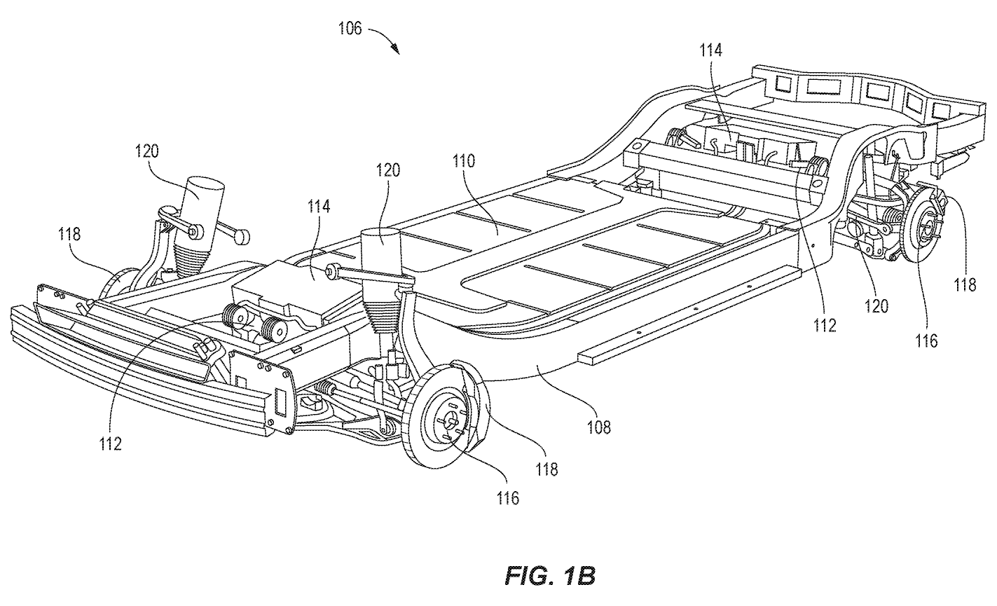

FIG. 1A illustrates an example vehicle 100. As seen in FIG. 1A, the vehicle 100 has multiple exterior cameras 102 and one or more front displays 104. Each of these exterior cameras 102 may capture a particular view or perspective on the outside of the vehicle 100. The images or videos captured by the exterior cameras 102 may then be presented on one or more displays in the vehicle 100, such as the one or more front displays 104, for viewing by a driver.

Referring to FIG. 1B, the vehicle 100 may include a chassis 106 including a frame 108 providing a primary structural member of the vehicle 100. The frame 108 may be formed of one or more beams or other structural members or may be integrated with the body of the vehicle (i.e., unibody construction).

In embodiments where the vehicle 100 is a battery electric vehicle (BEV) or possibly a hybrid vehicle, a large battery 110 is mounted to the chassis 106 and may occupy a substantial (e.g., at least 80 percent) of an area within the frame 108. For example, the battery 110 may store from 100 to 200 kilowatt hours (kWh). The battery 110 may be a lithium-ion battery or other type of rechargeable battery. The battery may be substantially planar in shape.

Power from the battery 110 may be supplied to one or more drive units 112. Each drive unit 112 may be formed of an electric motor and possibly a gear reduction drive. In some embodiments, there is a single drive unit 112 driving either the front wheels or the rear wheels of the vehicle 100. In another embodiment, there are two drive units 112, each driving either the front wheels or the rear wheels of the vehicle 100. In yet another embodiment, there are four drive units 112, each drive unit 112 driving one of four wheels of the vehicle 100.

Power from the battery 110 may be supplied to the drive units 112 by one or more sets of power electronics 114. The power electronics 114 may include inverters configured to convert direct current (DC) from the battery 110 into alternating current (AC) supplied to the motors of the drive units 112.

The drive units 112 are coupled to two or more hubs 116 to which wheels may mount. Each hub 116 includes a corresponding brake 118, such as the illustrated disc brakes. The drive units 112 or other component may also provide regenerative braking. Each hub 116 is further coupled to the frame 108 by a suspension 120. The suspension 120 may include metal or pneumatic springs for absorbing impacts. The suspension 120 may be implemented as a pneumatic or hydraulic suspension capable of adjusting a ride height of the chassis 106 relative to a support surface. The suspension 120 may include a damper with the properties of the damper being either fixed or adjustable electronically.

In the embodiment of FIG. 1B and in the discussion below, the vehicle 100 is a battery electric vehicle. However, the systems and methods disclosed herein may be used for any type of vehicle, including vehicles powered by an internal combustion engine (ICE), hybrid drivetrain, hydrogen fuel cell drivetrain, or other type of drivetrain that requires heating in preparation for use, such as diesel engines.

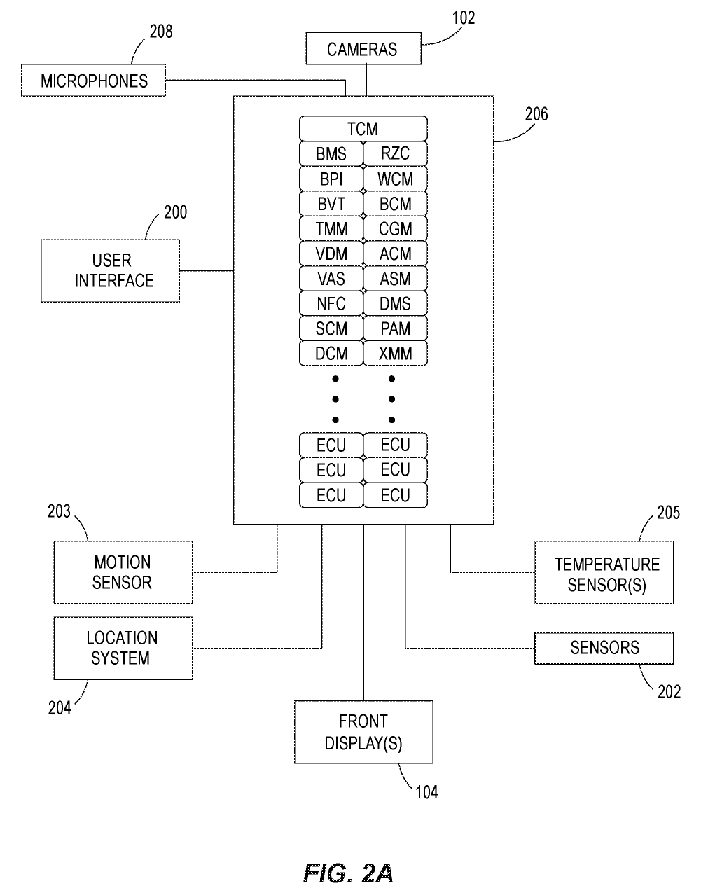

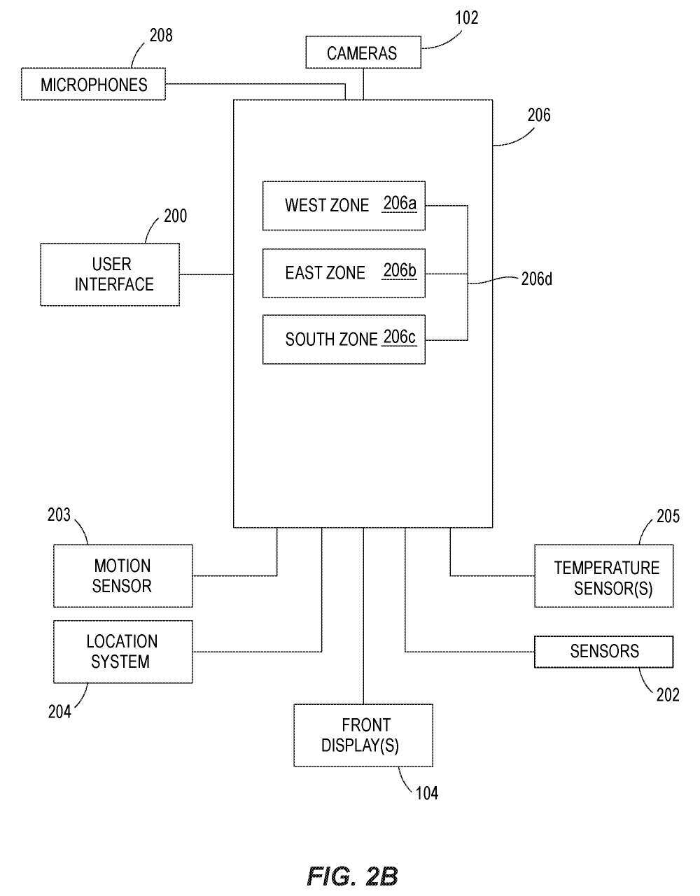

FIG. 2A illustrates example components of the vehicle 100 of FIG. 1A. As shown in FIG. 2A, the vehicle 100 includes the cameras 102, the one or more front displays 104, a user interface 200, one or more sensors 202, a motion sensor 203, and a location system 204. The one or more sensors 202 may include ultrasonic sensors, radio detection and ranging (RADAR) sensors, light detection and ranging (LIDAR) sensors, or other types of sensors. The location system 204 may be implemented as a global positioning system (GPS) receiver. The user interface 200 allows a user, such as a driver or passenger in the vehicle 100, to provide input.

The components of the vehicle 100 may include one or more temperature sensors 205. The temperature sensors 205 may include sensors configured to sense an ambient air temperature, temperature of the battery 110, temperature of power electronics 114, temperature of each drive unit 112 and/or each motor of each drive unit 112, or the temperature of any other component of the vehicle 100.

Certain features of the embodiments described herein may be controlled by a Telematics Control Module (TCM) ECU. The TCM ECU may provide a wireless vehicle communication gateway to support functionality such as, by way of example and not limitation, over-the-air (OTA) software updates, communication between the vehicle and the internet, communication between the vehicle and a computing device, in-vehicle navigation, vehicle-to-vehicle communication, communication between the vehicle and landscape features (e.g., automated toll road sensors, automated toll gates, power dispensers at charging stations), or automated calling functionality.

Certain features of the embodiments described herein may be controlled by a Central Gateway Module (CGM) ECU. The CGM ECU may serve as the vehicle’s communications hub that connects and transfer data to and from the various ECUs, sensors, cameras, microphones, motors, displays, and other vehicle components. The CGM ECU may include a network switch that provides connectivity through Controller Area Network (CAN) ports, Local Interconnect Network (LIN) ports, and Ethernet ports. The CGM ECU may also serve as the master control over the different vehicle modes (e.g., road driving mode, parked mode, off-roading mode, tow mode, camping mode), and thereby control certain vehicle components related to placing the vehicle in one of the vehicle modes.

In various embodiments, the CGM ECU collects sensor signals from one or more sensors of vehicle 100. For example, the CGM ECU may collect data from cameras 102 and sensors 202. The sensor signals collected by the CGM ECU are then communicated to the appropriate ECUs.

The control system 206 may also include one or more additional ECUs, such as, by way of example and not limitation: a Vehicle Dynamics Module (VDM) ECU, an Experience Management Module (XMM) ECU, a Vehicle Access System (VAS) ECU, a Near-Field Communication (NFC) ECU, a Body Control Module (BCM) ECU, a Seat Control Module (SCM) ECU, a Door Control Module (DCM) ECU, a Rear Zone Control (RZC) ECU, an Autonomy Control Module (ACM) ECU, an Autonomous Safety Module (ASM) ECU, a Driver Monitoring System (DMS) ECU, and/or a Winch Control Module (WCM) ECU. If vehicle 100 is an electric vehicle, one or more ECUs may provide functionality related to the battery pack of the vehicle, such as a Battery Management System (BMS) ECU, a Battery Power Isolation (BPI) ECU, a Balancing Voltage Temperature (BVT) ECU, and/or a thermal Management Module (TMM) ECU. In various embodiments, the XMM ECU transmits data to the TCM ECU (e.g., via Ethernet, etc.). Additionally or alternatively, the XMM ECU may transmit other data (e.g., sound data from microphones 208, etc.) to the TCM ECU.

Referring to FIG. 2B, in some embodiments, the control system 206 may be implemented as a plurality of zonal controllers 206a, 206b, 206c. Each zonal controller 206a, 206b, 206c may control a subset of systems of the vehicle. The subset of systems controlled by each zonal controller 206a, 206b, 206c may be generally assigned based on location within the vehicle 100. For example, a west zonal controller 206a may control systems on a driver side of the vehicle 100, an east zonal controller 206b may control systems on a passenger side of the vehicle 100, and a south zonal controller 206c may control systems in a rear portion of the vehicle. Each zonal controller 206a, 206b, 206c may implement a portion of the functions ascribed to the ECUs of the control system 206 of FIG. 2A. The functions of the ECUs may be distributed among the zonal controller 206a, 206b, 206c such that only one zonal controller 206a, 206b, 206c implements the functions of each ECU. Alternatively, the functions of an ECU may be duplicated across multiple zonal controllers 206a, 206b, 206c, each zonal performing the functions of the ECU for the portion of the vehicle to which that zonal controller 206a, 206b, 206c is assigned.

The zonal controllers 206a, 206b, 206c may be connected to one another by a network 206d, such as an Ethernet network, controller area network (CAN), or other type of network.

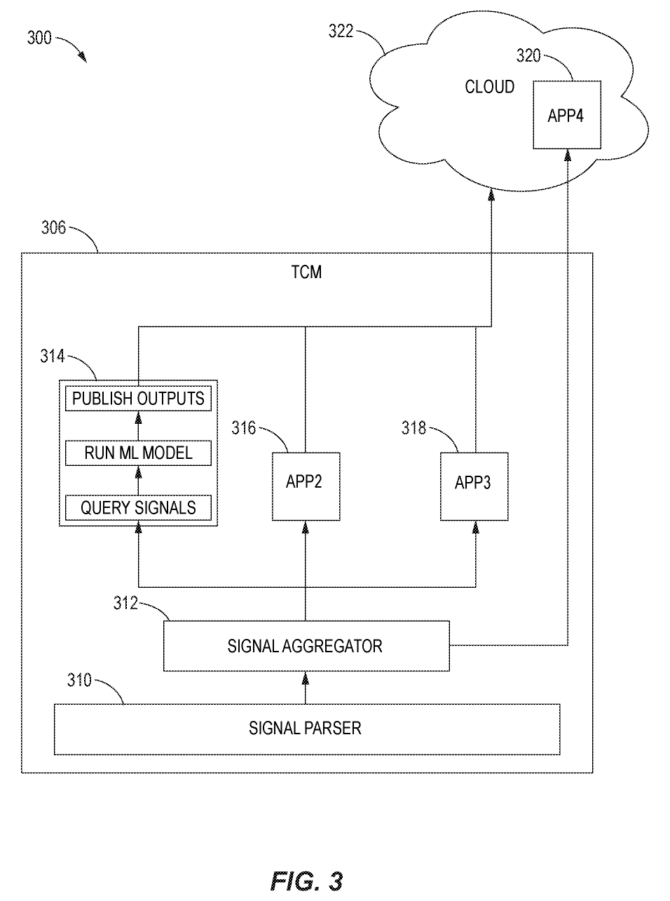

FIG. 3 illustrates an example environment 300 for a TCM 306, in accordance with certain embodiments. In general, the TCM 306 can operate as described relative to the TCM of FIG. 2A. In the example of FIG. 3, the TCM 306 includes a signal parser 310, a signal aggregator 312, and consumers 314, 316, 318, and 320. The environment 300 is also shown to include a cloud environment 322.

In certain aspects, the signal parser 310 is operable to parse, in real-time, one or more signals for one or more data points generated within the vehicle 100. The signal parser 310 can provide time-series inputs for each of the parsed signal(s) to the signal aggregator 312. In general, the signal(s) may relate to any suitable data point generated within the vehicle 100, such as speed, tire pressure, battery level, battery temperature, external factors like weather conditions and driving patterns, etc. Other examples of the signal(s) will be apparent to one skilled in the art after a detailed review of the present disclosure.

In certain aspects, the signal aggregator 312 is operable to receive the time-series inputs for each of the parsed signals in real-time and generate values of predetermined metrics based thereon. In some aspects, the predetermined metrics represent aggregations of a given signal for a predetermined time window (e.g., the last 10ms, 100ms, 500ms, 1s, 5s10s, 15s, etc.). The predetermined metrics can include, for example, maximum, minimum, sum, count, etc. In certain aspects, the signal aggregator 312 can maintain a different bin for each metric that is generated relative to a given signal (e.g., separate bins for each of maximum, minimum, sum, and count). In certain aspects, following generation and storage of the generated values in the associated bins, the time-series inputs can be discarded by the signal aggregator 312 (i.e., not stored), thereby achieving significant storage and performance improvements within the vehicle 100.

For a given signal and metric, an associated bin can include a plurality of values of the metric for a plurality of time windows of a predetermined period, sometimes referred to herein as a “bin window.” In general, the plurality of time windows correspond to a configurable time resolution for the metric (e.g., if a new value is generated every 10 seconds, the time resolution of the plurality of time windows would be 10 seconds). The bin window may correspond to a configurable lookback interval for the metric, where the interval is expressible, for example, as an amount of time, number of values, and/or the like. In an example, if the configurable time resolution of the metric is 15 seconds, the bin window may be a multiple thereof, such as six, thereby corresponding to a 90-second period. In another example, in some aspects, the bin can implement a ring buffer configured to store a predetermined number of values of the metric, such that each time a new value of the metric is stored, the oldest value in the bin is overwritten, thereby enforcing the bin window.

In certain aspects, the signal aggregator 312 is operable to receive and respond to requests for metric values, for example, from any of the consumers 314, 316, 318, and 320. In some aspects, the consumers 314, 316, 318, and/or 320 are operable to query the signal aggregator 312 in relation to the signal(s) discussed above, for example, by requesting one or more values of one or more metrics over a defined aggregation window (e.g., 30 seconds). In response to each query, the signal aggregator 312 can output or provide the requested value(s) to the consumers 314, 316, 318, and/or 320. In addition, or alternatively, the signal aggregator 312 can automatically push such values to the consumers 314, 316, 318, and/or 320 at regular intervals without an explicit request (e.g., in correspondence to the time resolution of an associated bin of values or a multiple thereof).

In general, the consumers 314, 316, 318, and 320 are each operable to receive value(s) of metric(s) from the signal aggregator 312, for example, in response to a query or an automatic push as discussed above. Thereafter, the consumers 314, 316, 318, and 320 can process the value(s) according to an algorithm, model, or the like to produce one or more outputs. For example, as shown in FIG. 3, the consumer 314 executes an in-vehicle ML framework that queries the signal aggregator 312 in relation to the signal(s) as discussed above, runs an ML model based on one or more metric values received from the signal aggregator 312 in response to the query, and publishes one or more outputs produced by the ML model, for example, to the cloud environment 322 (e.g., to a remote server executing in the cloud environment 322, a database within vehicle 100, the user interface 200 of FIGS. 2A-B, and/or elsewhere). It should be appreciated that, in various aspects, the consumers 316, 318, and/or 320 can include similar or different functionality compared to that of the consumer 314.

For illustrative purposes, the consumers 314, 316, and 318 are shown as software applications executing within the TCM 306. It should be appreciated, however, that the consumers 314, 316, and 318 can also operate elsewhere in the vehicle 100. For example, the consumers 314, 316, and 318 can correspond to, or execute within, any of the ECUs or controllers discussed relative to the control system 206 of FIGS. 2A-B. Similarly, for illustrative purposes, the consumer 320 is shown as a software application executing within the cloud environment 322. It should be appreciated, however, that the consumer 320 can operate at any suitable remote location relative to the vehicle 100. More generally, it should be appreciated that the number and types of consumers can be configured to suit a given implementation, and such consumers may operate in any suitable location inside or outside the vehicle 100.

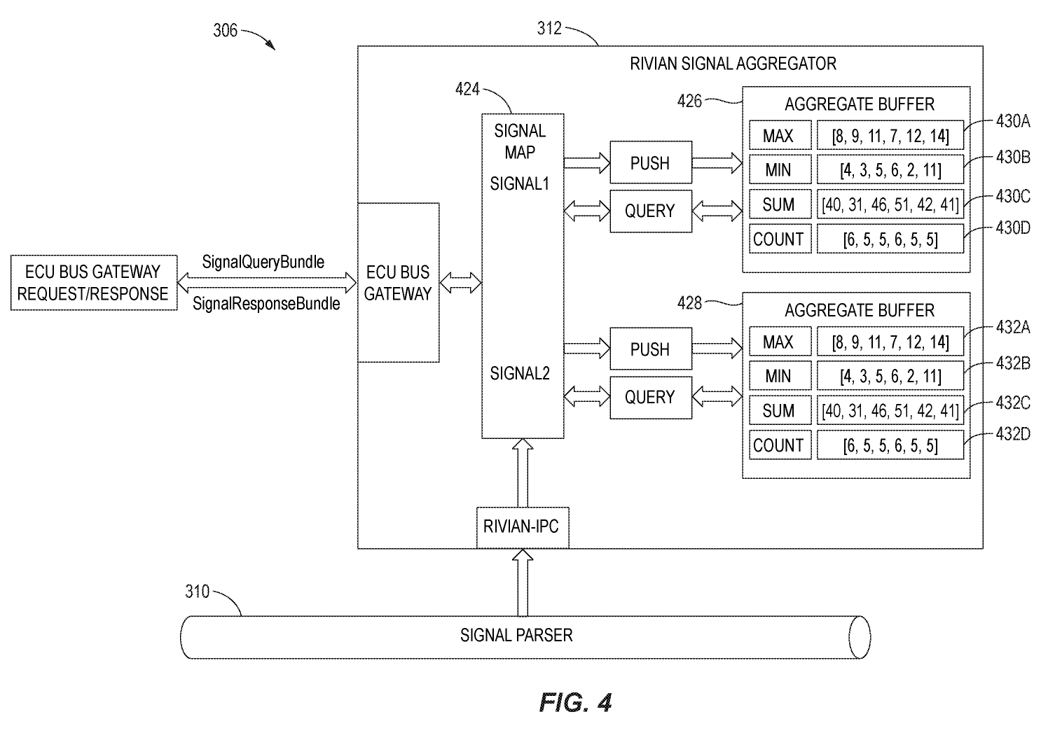

FIG. 4 illustrates example operation of the TCM 306 of FIG. 3, in accordance with certain embodiments. In the example of FIG. 4, the signal aggregator 312 maintains a signal map 424 that maps one or more individual signals within the vehicle 100 to individual aggregate buffers. In the example of FIG. 4, a first signal, denoted as “Signal1,” is mapped to an aggregate buffer 426, while a second signal, denoted as “Signal2,” is mapped to an aggregate buffer 428. The first and second signals can each relate to a data point generated within the vehicle, as discussed above relative to FIG. 3.

With continued reference to FIG. 4, the aggregate buffers 426 and 428 each aggregate a set of bins, where each bin is implemented as a ring buffer configured to store values of a metric related to the corresponding mapped signal. In particular, in the example of FIG. 4, the aggregate buffer 426 includes bins 430A, 430B, 430C, and 430D configured to store, with respect to the first signal, values for maximum, minimum, sum, and count, respectively. In similar fashion, in the example of FIG. 4, the aggregate buffer 428 includes bins 432A, 432B, 432C, and 432D configured to store, with respect to the second signal, values for maximum, minimum, sum, and count, respectively. It should be noted that the foregoing metrics are merely examples, and that any of the aforementioned bins can be configured to store values of other metrics without deviating from the present disclosure.

For the first signal noted above (i.e., “Signal1”), the bins 430A-D each include a plurality of values for a plurality of time windows of a bin window for the respective bin. For example, the bin 430A may include six maximum values for a sequence of six 15-second time windows. According to this example, the time resolution of the bin 430A may be 15 seconds, and the bin window may be implemented via a six-value capacity of the bin 430A. Each time the signal aggregator 312 generates a new maximum value with respect to the first signal (e.g., every 15 seconds), the signal aggregator 312 can push the new maximum value to the bin 430A for storage, which causes the oldest maximum value in the bin 430A to be overwritten in accordance with the example six-value bin window. In certain aspects, the signal aggregator 312 can update indices associated with the bin 430A (e.g., starting and/or end indices) as older values are overwritten in order to maintain a time sequence of the values therein.

The bins 430B, 430C, and 430D can be configured as generally described relative to the bin 430A, except for minimum, sum, and count values, respectively. The bins 432A-D can be configured as described with respect to the bins 430A-D, except in relation to the second signal noted above (i.e., “Signal2”). It should be appreciated that the number and types of bins can vary from those shown in FIG. 4 to suit particular embodiments.

As discussed relative to FIG. 3, the signal parser 310 can parse, in real-time, the first and second signals, and can provide time-series inputs for each of the parsed signals to the signal aggregator 312. The signal aggregator 312 can receive the time-series inputs for each of the parsed signals in real-time and can apply predetermined functions to the time-series inputs to generate new metric values for storage. For example, the signal aggregator 312 can apply maximum, minimum, sum, and count functions to time-series inputs parsed from the first signal to generate new maximum, minimum, sum, and count values for storage in the bins 430A, 430B, 430C, and 430D, respectively, as discussed above. Similarly, the signal aggregator 312 can apply maximum, minimum, sum, and count functions to time-series inputs parsed from the second signal to generate new maximum, minimum, sum, and count values for storage in the bins 432A, 432B, 432C, and 432D, respectively, as discussed above.

As also discussed relative to FIG. 3, the signal aggregator 312 can receive and respond to requests for metric values from consumers. In an example, a consumer, such as any of the consumers 314, 316, 318, and/or 320 of FIG. 3, can query the signal aggregator 312 in relation to the first signal by requesting a maximum value over a defined aggregation window, for example, of 45 seconds. Assuming an illustrative 15-second time resolution for the bin 430A, in response, the signal aggregator 312 can aggregate the last three maximum values in the bin 430A based on the aggregation window to generate the requested value. For example, the signal aggregator can apply a maximum function to the aforementioned values of the aggregation window to generate the requested value. The bins 430B, 430C, and 430D can be similarly utilized for querying minimum, sum, and count values, respectively. The bins 432A-D can be utilized for querying as described with respect to the bins 430A-D, except in relation to the second signal noted above (i.e., “Signal2”).

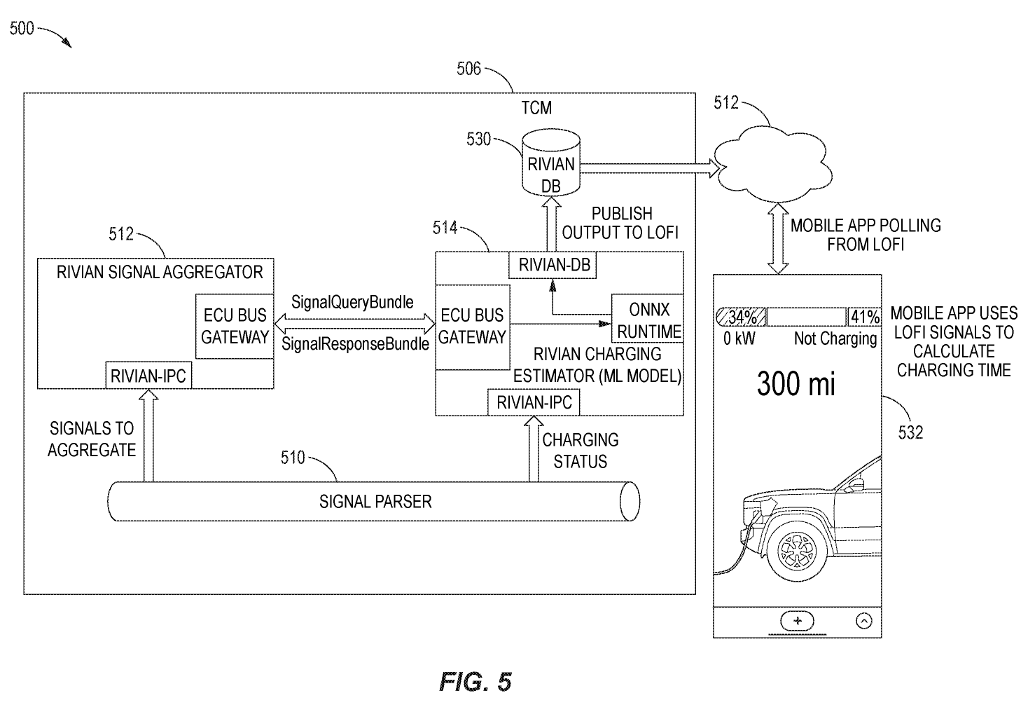

FIG. 5 illustrates an example environment 500 for estimating vehicle battery charge time, in accordance with certain embodiments. The environment 500 includes a TCM 506 and a cloud environment 522 that may operate as discussed relative to the TCM 306 and the cloud environment 322, respectively, described relative to FIGS. 3 and 4. The TCM 506 includes a signal parser 510, a signal aggregator 512, and a consumer 514 that can operate as described, for example, relative to the signal parser 310, the signal aggregator 312, and the consumer 314, respectively, of FIG. 3. The TCM 306 is also shown to include a database 530. In the example of FIG. 5, the consumer 514 executes an in-vehicle ML framework for estimating vehicle battery charge time via an ML model.

In a particular example utilizing the environment 500, a charge estimation process can begin with a vehicle, such as the vehicle 100 of FIG. 1A, being plugged into a charger, in response to which a charging status signal indicative of charging is generated within the vehicle. The consumer 514 can receive the charging status signal, for example, via the signal parser 510. In response to the charging status signal, the consumer 514 can query the signal aggregator 512 in relation to one or more signals, for example, by requesting one or more values of one or metrics over a defined aggregation window (e.g., 15 seconds). The requested value(s) may correspond to inputs utilized by the ML model of the consumer 514 to estimate, for example, vehicle battery charge time.

Continuing the foregoing example, in response to the query from the consumer 514, the signal aggregator 512 can aggregate binned values for each of the metric(s), as discussed above relative to FIG. 4, to generate the requested value(s). The signal aggregator 512 can thereafter provide or output the requested value(s) to the consumer 514. In response to receiving the requested value(s) from the signal aggregator 512, the consumer 514 can run the ML model based on the received value(s) to generate one or more outputs, such as an estimate of vehicle battery charge time. The consumer 514 can publish the output(s), for example, to the database 530 and/or the cloud environment 522. In certain aspects, publication of the output(s) can further cause information related to the output(s) to be presented on a user interface such as the user interface 200 of FIG. 2A and/or 2B, a user interface provided by a mobile device associated with a user of the environment 500, etc. FIG. 5 shows an example user interface 532 that may be presented on a mobile device associated with a user (e.g., a mobile device associated with a vehicle driver or passenger).

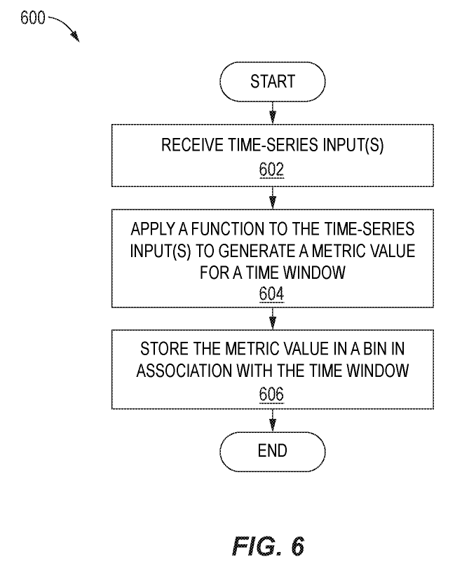

FIG. 6 illustrates an example of a process 600 for maintaining metric values based on time-series inputs within a vehicle, in accordance with certain embodiments. Although, for simplicity of illustration, the process 600 is described relative to a single metric, in certain aspects, the process 600 can be executed in parallel for multiple metrics. Further, although a single iteration is described for clarity, it should be appreciated that the process 600 can execute repeatedly, for example, as new time-series inputs are received.

In certain aspects, the process 600 can be executed, for example, by any of the ECUs or controllers discussed relative to the control system 206 of FIGS. 2A-B. For example, the process 600 can be executed by the TCM 306 and/or the TCM 506 of FIGS. 3 and 5, respectively, and/or a component thereof. In addition, or alternatively, the process 600 can be executed, for example, by the signal aggregator 312 of FIG. 3 and/or the signal aggregator 512 of FIG. 5. Although the process 600 can be executed by any number of systems or components, for illustrative purposes, the process 600 will be described as being performed by a vehicle control system.

At block 602, the vehicle control system receives one or more time-series inputs associated with a time window (e.g., values of a data point for the last 500 ms, 1000 ms, 10s, 15s, etc.). The one or more time-series inputs may be received, for example, via a signal parser such as the signal parser 310 of FIG. 3 or the signal parser 510 of FIG. 5, as discussed above relative to FIGS. 3-5.

At block 604, the vehicle control system applies a function to the time-series input(s) received at block 602 to generate a value of a metric for the vehicle (e.g., min, max, sum, count, range, mean, median, mode, variance, standard deviation, etc.). The metric can be generated, for example, as discussed above relative to FIGS. 3-5.

At block 606, the vehicle control system stores the value of the metric in a bin for the metric in association with the time window. The value of the metric can be stored, for example, as discussed above relative to FIGS. 3-5. The storing can include, for example, overwriting at least one other value of the metric in the bin (e.g., the oldest value) as discussed previously. In some aspects, following storage of the value in the bin, the time-series inputs received at block 602 can be discarded (e.g., not stored), thereby achieving significant storage and performance improvements within the vehicle. After block 606, the process 600 ends.

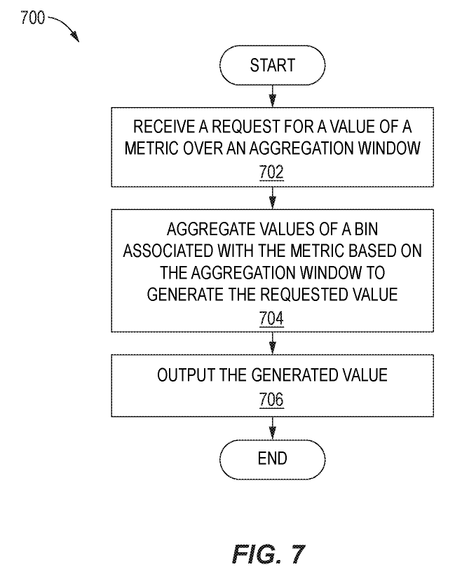

FIG. 7 illustrates an example of a process 700 for responding to queries for metric values stored within a vehicle, in accordance with certain embodiments. Although, for simplicity of illustration, the process 700 is described relative to a single metric, in certain aspects, the process 700 can be executed in parallel for multiple metrics (e.g., for queries requesting values of multiple metrics).

In certain aspects, the process 700 can be executed, for example, by any of the ECUs or controllers discussed relative to the control system 206 of FIGS. 2A-B. For example, the process 700 can be executed by the TCM 306 and/or the TCM 506 of FIGS. 3 and 5, respectively, and/or a component thereof. In addition, or alternatively, the process 700 can be executed, for example, by the signal aggregator 312 of FIG. 3 and/or the signal aggregator 512 of FIG. 5. Although the process 700 can be executed by any number of systems or components, for illustrative purposes, the process 700 will be described as being performed by a vehicle control system.

At block 702, the vehicle control system receives a request for a value of a metric over an aggregation window (e.g., 30 seconds, 45 seconds, etc.). The request may be received from a consumer (e.g., a software application executing in the vehicle) as discussed, for example, relative to FIGS. 3-5.

At block 704, the vehicle control system aggregates values of a bin associated with the metric based on the aggregation window to generate the requested value. The values can be aggregated, for example, as discussed above relative to FIGS. 3-5.

At block 706, the vehicle control system outputs the value generated at block 704, for example, to a consumer that requested the value. The generated value can be output, for example, as discussed above relative to FIGS. 3-5. After block 706, the process 700 ends.

The descriptions of the various embodiments of the present disclosure have been presented for purposes of illustration. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

In the preceding, reference is made to embodiments presented in this disclosure. However, the scope of the present disclosure may exceed the specific described embodiments. Instead, any combination of the features and elements, whether related to different embodiments, is contemplated to implement and practice contemplated embodiments. Furthermore, although embodiments disclosed herein may achieve advantages over other possible solutions or over the prior art, the embodiments may achieve some advantages or no particular advantage. Thus, the aspects, features, embodiments and advantages discussed herein are merely illustrative.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.”

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment ("CPP embodiment" or “CPP”) is a term used in the present disclosure to describe any set of one, or more, storage media (also called "mediums") collectively included in a set of one, or more, storage devices that collectively include machine readable code corresponding to instructions and/or data for performing computer operations specified in a given CPP claim. A "storage device" is any tangible device that can retain and store instructions for use by a one or more computer processing devices. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Certain types of storage devices that include these mediums include: diskette, hard disk, random access memory (RAM), read only memory (ROM), erasable programmable read only memory (EPROM or Flash memory), static random access memory (SRAM), compact disc read only memory (CD-ROM), digital versatile disk (DVD), memory stick, floppy disk, mechanically encoded device (such as punch cards or pits / lands formed in a major surface of a disc) or any suitable combination of the foregoing. A computer readable storage medium, as that term is used in the present disclosure, refers to non-transitory storage rather than transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but the storage device remains non-transitory during these processes because the data remains non-transitory while stored.

What is claimed is:

1. A method for in-vehicle edge processing of time-series data, comprising:
receiving, by a vehicle control system of a vehicle, one or more first time-series inputs associated with a first time window, wherein the one or more first time-series inputs relate to one or more signals generated within the vehicle;
applying, by the vehicle control system, a first function to the one or more first time-series inputs to generate a first value of a first metric for the first time window; and
storing, by the vehicle control system, the first value of the first metric in the vehicle in a first bin in association with the first time window.

2. The method of claim 1, wherein the first bin comprises a plurality of values of the first metric for a plurality of time windows of a period, the plurality of values including the first value of the first metric for the first time window.

3. The method of claim 2, wherein:
the first bin implements a ring buffer configured to store a predetermined number of values of the first metric; and
the storing the first value of the first metric comprises overwriting at least one other value of the plurality of values of the first metric.

4. The method of claim 2, wherein the plurality of time windows corresponds to a predetermined time resolution for the first metric.

5. The method of claim 2, further comprising, by the vehicle control system:
receiving one or more second time-series inputs associated with a second time window;
applying the first function to the one or more second time-series inputs to generate a second value of the first metric for the second time window; and
storing the second value of the first metric in the first bin in association with the second time window.

6. The method of claim 2, further comprising, by the vehicle control system:
receiving a request for a value of the first metric over an aggregation window;
aggregating the plurality of values of the first bin based on the aggregation window to generate the requested value; and
outputting the generated requested value.

7. The method of claim 6, wherein the generated requested value is output to a machine learning model within the vehicle, the method further comprising running the machine learning model based on the generated requested value.

8. The method of claim 1, further comprising, by the vehicle control system:
applying a second function to the one or more first time-series inputs to generate a value of a second metric for the first time window; and
storing the value of the second metric in a second bin in association with the first time window.

9. The method of claim 8, wherein the second bin comprises a plurality of values of the second metric for a plurality of time windows of a period, the plurality of values including the value of the second metric for the first time window.

10. The method of claim 1, further comprising discarding the one or more first time-series inputs responsive to the first value of the first metric being stored in the first bin.

11. The method of claim 1, wherein the first value of the first metric comprises an aggregate value associated with the one or more first time-series inputs.

12. The method of claim 1, wherein the first value of the first metric comprises at least one of a maximum, minimum, sum, or count of the one or more first time-series inputs.

13. A system for in-vehicle edge processing of time-series data, comprising:
one or more memories comprising executable instructions; and
one or more processors in data communication with the one or more memories and configured to execute the executable instructions to:
receive one or more first time-series inputs associated with a first time window, wherein the one or more first time-series inputs relate to one or more signals generated within a vehicle;
apply a first function to the one or more first time-series inputs to generate a first value of a first metric for the first time window; and
store the first value of the first metric in the vehicle in a first bin in association with the first time window.

14. The system of claim 13, wherein the first bin comprises a plurality of values of the first metric for a plurality of time windows of a period, the plurality of values including the first value of the first metric for the first time window.

15. The system of claim 14, wherein:
the first bin implements a ring buffer configured to store a predetermined number of values of the first metric; and
the storage of the first value of the first metric comprises overwriting at least one other value of the plurality of values of the first metric.

16. The system of claim 14, wherein the one or more processors are further configured to execute the executable instructions to:
receive one or more second time-series inputs associated with a second time window;
apply the first function to the one or more second time-series inputs to generate a second value of the first metric for the second time window; and
store the second value of the first metric in the first bin in association with the second time window.

17. The system of claim 14, wherein the one or more processors are further configured to execute the executable instructions to:
receive a request for a value of the first metric over an aggregation window;
aggregate the plurality of values of the first bin based on the aggregation window to generate the requested value; and
output the generated requested value.

18. The system of claim 17, wherein the generated requested value is output to a machine learning model within the vehicle, wherein the one or more processors are further configured to execute the executable instructions to run the machine learning model based on the generated requested value.

19. The system of claim 13, wherein the one or more processors are further configured to execute the executable instructions to discard the one or more first time-series inputs responsive to the first value of the first metric being stored in the first bin.

20. A computer-program product comprising a non-transitory computer-usable medium having computer-readable program code embodied therein, the computer-readable program code adapted to be executed to implement a method comprising:
receiving one or more first time-series inputs associated with a first time window, wherein the one or more first time-series inputs relate to one or more signals generated within a vehicle;
applying, by the vehicle control system, a first function to the one or more first time-series inputs to generate a first value of a first metric for the first time window; and
storing, by the vehicle control system, the first value of the first metric in the vehicle in a first bin in association with the first time window.
